(19) United States
(12) Patent Application Publication
(10) Pub. No.: US 2017/0106853 A1
(43) Pub. Date: Apr. 20, 2017

(54) METHOD FOR OPERATING AN ELECTRIC MACHINE

(71) Applicant: AUDI AG, 85045 Ingolstadt (DE)

(72) Inventors: Josef Rusch, Grossmehring (DE); Andreas Petz, Ingolstadt (DE); Roman Strasser, Gaimersheim (DE)

(73) Assignee: AUDI AG, 85045 Ingolstadt (DE)

(21) Appl. No.: 15/297,765

(22) Filed: Oct. 19, 2016

(30) Foreign Application Priority Data
Oct. 19, 2015 (DE) 102015013541.4

(51) Int. Cl. B60W 20/10; B60W 10/08; B60W 30/188; B60W 10/06

(52) U.S. Cl. CPC B60W 20/10; B60W 10/06; B60W 10/08; B60W 30/188; B60W 2520/40; B60W 2720/40; Y10S 903/902

(57) ABSTRACT

A method for operating an electric machine which is coupled with an output shaft of an internal combustion engine of a motor vehicle includes controlling the electric machine in dependence on at least one operating parameter of at least one of the internal combustion engine and the electric machine so that the electric machine transmits to the output shaft a compensation torque which at least partially compensates torque fluctuations of the internal combustion engine occurring during an operation of the internal combustion engine as a result of an operating phase of the internal combustion engine.

### CROSS-REFERENCES TO RELATED APPLICATIONS

This application claims the priority of German Patent Application, Serial No. 10 2015 013 541.4, filed Oct. 19, 2015, pursuant to 35 U.S.C. 119(a)-(d), the content of which is incorporated herein by reference in its entirety as if fully set forth herein.

### BACKGROUND OF THE INVENTION

The present invention relates to a method for operating an electric machine, which is coupled with a output shaft of an internal combustion engine of a motor vehicle.

The following discussion of related art is provided to assist the reader in understanding the advantages of the invention, and is not to be construed as an admission that this related art is prior art to this invention.

In internal combustion engines, in particular in four-stroke cylinder engines, the stroke sequence of intake, compression combustion and exhaust leads to the fact that a torque that varies over time is transmitted from the motor to the crankshaft. It is possible that as a result of this variation of the provided torque over time rotation vibrations are coupled into the output shaft. In order to dampen these vibrations it is known to use a so-called dual mass flywheel which includes two flywheels, one of which is arranged on the side of the motor and another one on the side of the transmission, and which are connected with spring- and damper elements.

Such dual mass flywheels are relatively costly and are subject to wear at increased mileages. In addition they may limit the power of the motor vehicle.

It would be desirable and advantageous to provide an improved method for reducing rotation vibrations in the work cycle of a motor vehicle.

### SUMMARY OF THE INVENTION

According to one aspect of the present invention, a method for operating an electric machine which is coupled with an output shaft of an internal combustion engine of a motor vehicle includes controlling the electric machine in dependence on at least one operating parameter of at least one of the internal combustion engine and the electric machine so that the electric machine transmits to the output shaft a compensation torque which at least partially compensates torque fluctuations of the internal combustion engine occurring during an operation of the internal combustion engine as a result of an operating phase of the internal combustion engine

According to the present invention an electric machine that is coupled with the output shaft is controlled in order to actively compensate torque fluctuations of the internal combustion engine. The term torque fluctuations in this context means the essentially periodical variations of the torque of the internal combustion engine which result due to the work cycle of individual cylinders or the phase of the respective work cycle. These torque fluctuations are superimposed over a torque which the internal combustion engine is to provide. The electric machine can be an electric machine that is used in the motor vehicle in order to generate energy as a generator and/or as electric motor to increase the drive power of the motor vehicle.

The electric machine can be configured as an external rotor machine. At same constructive dimensions the rotor of an electric machine that is configured as external rotor machine has a greater rotation inertia than the rotor of a machine that is configured as an internal rotor machine because it has a greater radius. Because the electric machine and with this the rotor is coupled with the output shaft also the rotation inertia of the output shaft is increased. A greater rotation inertia of the output shaft however leads to the fact that high-frequency torque fluctuations are dampened at the output shaft which allows achieving an improved damping of rotation vibrations due to operating phases of the internal combustion engine.

The electric machine can have a rotor that is coupled with the output shaft in rotative fixed relationship. This achieves a direct damping of the vibrations on the output shaft. As an alternative it is possible to couple the rotor of the electric motor to the output shaft via gearwheels, a planetary gear set, belts, transmissions or the like.

The operating parameter of the electric machine that is analyzed can be a detected rotation angle and/or a detected rotational speed of the electric machine. The electric machine is preferably coupled o the drive shift in rotative fixed relationship with the output shaft or via a fixed transmission ratio. Thus the relationship between the rotational speed of the internal combustion engine and the rotational speed of the electric machine and between a rotation angle of the internal combustion engine and a rotation angle of the electric machine is known.

When taking a rotation angle of the electric machine as operating parameter into account a rotation angle can be analyzed so that multiple revolutions of the electric machine are taken into account. A four stroke operating cycle of an internal combustion engine includes for example four piston strokes and thus typically two revolutions of a crankshaft. An operating cycle thus corresponds to a rotation of the crankshaft by 720°. In case of a rotatively fixed connection between the rotor and the output shaft the rotor also rotates by 720°. Depending on the internal combustion engine and the transmission ratio between the output shaft and the rotor of the electric machine, different angular ranges can be detected. Rotational angles of more than 360° can for example be detected by detecting a rotation angle in the range of 0 to 360° wherein a counter counts the number of performed revolutions.

The operating parameter of the internal combustion engine can be provided by a motor control of the internal combustion engine. Modern motor vehicles typically include motor controls which detect a plurality of operating parameters of the motor for example the ignition time points and a position of a crankshaft and/or camshaft and provide control signals for example for the injection valves and the ignition. Based on these operating parameters and/or control signals an actual operating phase of the internal combustion engine and with this an expected fluctuation of the provided torque can be determined. Because the data processing is typically performed digitally I the motor control corresponding data can be easily be provided to a control device of the electric machine, for example via a CAN-bus. It is also possible to integrate a control device for the electric machine into the motor control of the internal combustion engine.

The analyzed operating parameter of the internal combustion engine can be an actual cycle of at least one cylinder of the internal combustion engine and/or a phase within a cycle. In a four stroke engine the term cycle includes the four cycles of intake, compression, combustion and exhaust. A phase within the respective cycle can correspond to a position of the piston in a cylinder or a rotation angle of the crankshaft.

Depending on the type of the electric machine the electric machine can be controlled in different ways. When the electric machine is exclusively used as a generator a torque exerted on the output shaft can be varied by varying an electrical load at the electric machine that is operated as a generator. When operated as an electric motor the power supplied to the electric motor can be varied. When a vector regulation is already provided for the electric machine the torque on the output shaft can be adjusted via this vector regulation.

The level of the torque transmitted by the electric machine on the output shaft can be fixed in dependence on the detected operating parameter or parameters of the internal combustion engine of the electric machine. For example lookup-tables or algorithms can be stored in a control device of the electric machine which enable a conversion of the operating parameter or parameters into one or more control variables. However, the control may also be performed in the manner of a regulatory circuit, wherein one or more control variables can be increased or decreased in dependence on an operating parameter or a variable derived from one or more operating parameters. This can for example be accomplished by a proportional and/or an integral regulation.

For increasing the driving performance or for recuperation of energy the electric machine can be controlled so that it transmits a torque to the output shaft which is the sum of a predetermined drive power torque or recuperation torque and a compensation torque which at least partially compensates the torque fluctuations of the internal combustion engine due to its operating phase. The drive power or recuperation torque and the compensation torque can be of same direction or can be directed opposite to each other.

Beside the method according to the invention the invention also relates to a motor vehicle which has an internal combustion engine, an electric machine coupled with the internal combustion engine and a control device for controlling the electric machine wherein the control device is configured for implementing the method according to the invention. The electric machine can be configured as an external rotor machine. The rotor of the electric machine can be coupled with the output shaft in rotative fixed relationship.

Of course features which are disclosed with regard to the motor vehicle according to the invention and features that are disclosed regarding the method according to the invention can be correspondingly applied to the respectively other subject of the invention.

### BRIEF DESCRIPTION OF THE DRAWING

Other features and advantages of the present invention will be more readily apparent upon reading the following description of currently preferred exemplified embodiments of the invention with reference to the accompanying drawing, in which

FIG. 1 shows a flow chart of an exemplary embodiment of the method according to the invention;

FIG. 2 shows an exemplary embodiment of a motor vehicle according to the invention, and

FIG. 3 shows a detail view of the motor vehicle according to the invention shown in FIG. 2.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

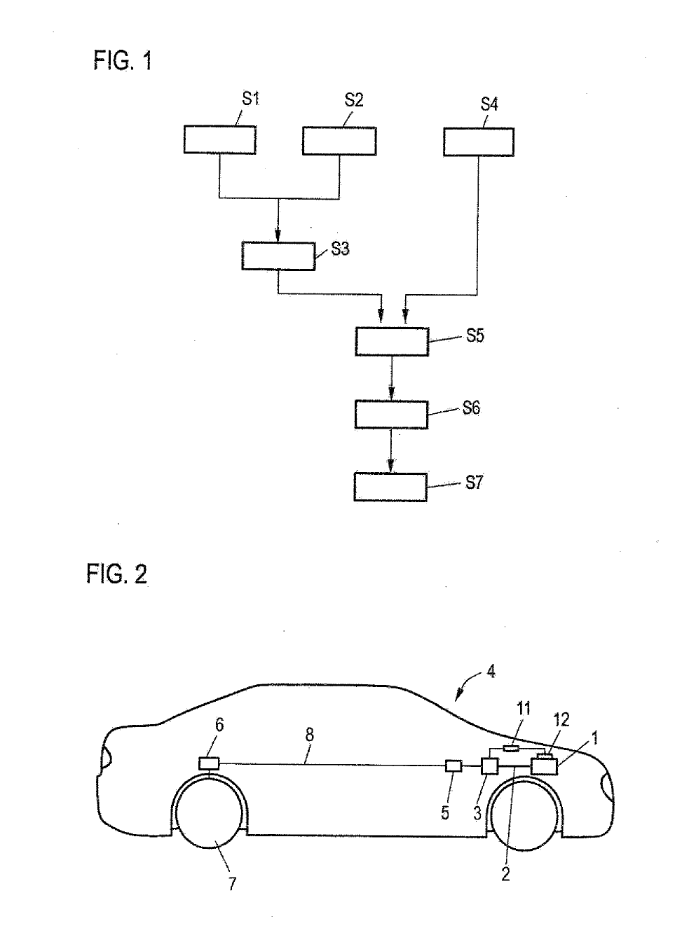

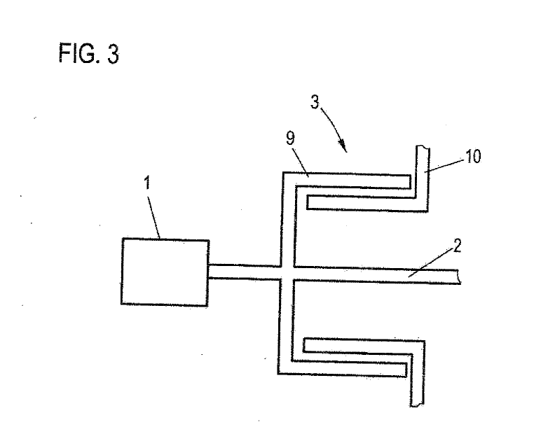

FIG. 1 shows a method for operating an electric machine which is coupled with an output shaft of an internal combustion engine of a motor vehicle. The method is explained with reference to FIG. 2 and FIG. 3, wherein FIG. 2 shows a motor vehicle 4 which has an internal combustion engine 1, a output shaft 2 of the internal combustion engine 1 and an electric machine 3 coupled with the output shaft 2. FIG. 3 shows a detail view of these components.

The motor vehicle 4 is driven by the internal combustion engine 1, in which a torque of the internal combustion engine 1 is transmitted to the transmissions via the output shaft 2, from which transmission it is distributed to the rear wheels 7 after via the differential 6 after a transmission ratio to the intermediate shaft 8. The internal combustion engine 1 is in this case a four stroke motor whose torque fluctuates during the course of its four strokes. A cylinder of the internal combustion engine 1 can only provide a torque to the output shaft 2 in its work cycle. In other cycles, in particular the compression cycle, work has to be expended in order to move the piston of the cylinder, which is why in these cycles a negative torque is transmitted to the output shaft. Also within the individual cycles, the provided or received torque varies. These torque fluctuations can be partially compensated by using multiple cylinders that operate in a phase shifted manner. In order to save weight in the motor vehicle 4 however oftentimes an internal combustion engine with a low number of cylinders, for example with three or four cylinders, is used. As the number of cylinders decreases the unevenness of the provided torque increases, which leads to transmission of vibrations to the output shaft and with this via the transmission 5 to the intermediate shaft 8.

These vibrations are intended to be actively damped by the method shown in FIG. 1. To this end in step S1 an operating parameter of the electric machine 3, i.e., a rotation angle of the rotor 9, is first detected. As shown in FIG. 3, the rotor 9 of the electric machine 3 is rigidly connected with the output shaft 2 of the internal combustion engine 1. The rotor 9 rotates as external rotor about the stator 10 of the electric machine 3. For clarity the coils and permanent magnets of the electric machine 3 are not shown. Because the rotor 9 is rigidly coupled with the output shaft 2 a rotation angle of the rotor 9 corresponds to a rotation angle of the output shaft 2, which can be directly assigned to a position of the individual cylinders. The rotation angle of the electric machine 3 or the rotor 9 can be detected by a sensor, however it is also possible to read out a rotation angle directly form a control device 11 which controls the electric machine 3. In the shown example the control of the electric machine 3 is accomplished by a vector regulations in anyway a rotor position of the electric motor is detected.

Due to the fact that the internal combustion engine 1 is a four stroke engine a work cycle of each cylinder includes four strokes and thus four piston lifts. Therefore a work phase of the respective cylinder and with this the entire internal combustion engine 1 cannot be unambiguously determined solely based on a rotation angle of the rotor 9 or an output shaft 2. Therefore in step S2 the control device 11 additionally requests from a motor control 12 of the internal combustion engine 1 a cycle information which describes the actual cycle of at least one cylinder of the internal combustion engine.

From the information detected in the steps S1 and S2 an operating phase of the internal combustion engine 1 is unequivocally determined in step S3 and a compensation torque that is assigned to this operating phase is determined. This is accomplished with a predetermined algorithm. As an alternative a lookup table may be used.

The magnitude of the torque fluctuations generated in the different operating phases of the internal combustion engine 1 can depend on further parameters, in particular on the rotational speed of the internal combustion engine 1. Therefore further parameters of the electric machine 3 and/or the internal combustion engine 1 can be detected by not further shown steps, in particular a rotational speed of the internal combustion engine or the electric machine 3 an the determination of the compensation torque in step S3 can be performed in dependence on these further parameters.

In the method according to the invention the electric machine 3 can also be used in to recuperate electrical energy during a braking procedure of the motor vehicle and an additional torque is provided during an acceleration process of the motor vehicle 4 for accelerating the motor vehicle 4. In step S4 therefore a torque is determined which is transmitted additionally as boost torque to the output shaft 2 or is converted as recuperation torque into electrical energy. The boost torque or the recuperation torque is determined in dependence on multiple vehicle parameters in particular in dependence on a gas pedal position, a gear selected in the transmission and/or a set operating mode of the motor vehicle which indicates in how far a particularly sporty driving or energy saving driving is desired. Methods for determining boost or recuperation torques are known in the state of the art and are not described in detail.

In step S5 the compensation torque determined in step S3 is added to the boost or recuperation torque determined in step S4 in order to determine a total torque that is to be transmitted by the electric machine 3 to the output shaft. In step S6 variables for the electric machine 3 are determined by the control device 11 based on this total torque. In the used vector regulation in particular a predetermined target value of the vector regulation can be set according to the total torque determined in step S5. As an alternative it is also possible to directly determine the coil currents or coil voltages for coils of the electric machine 3 and output the coil current and coil voltages via a digital-analog-converter. In step S7 the electric machine 3 is controlled in dependence on the control variables determined in step S6.

In order to achieve an efficient damping of the vibrations excited caused on the output shaft 2 by the torque fluctuations of the internal combustion engine 1 the rotor of the electric machine 3 as shown in FIG. 3 is rigidly connected with the output shaft 2. The rigid connection avoids using potentially wear sensitive coupling elements between the rotor 9 and the output shaft 2.

In the shown example the electric machine 3 is configured as an external rotor machine in which the rotor 9 rotates about a stator 10 that is arranged inside the rotor 9. Compared to an electric machine of the same size which is configured as an inner rotor machine the illustrated configuration of the electric machine 3 or the rotor 9 results in a greater rotation inertia of the electric machine 3 or the rotor 9. Due to the rigid coupling of the rotor 9 with the output shaft 2 this leads to the fact that also the rotation inertia of the output shaft 2 is greater than when using an inner rotor which effectively achieves a low pass filtering of the torques transmitted to the output shaft 2. The torque fluctuations caused by the different operating phases of the internal combustion engine 1 are more high-frequent than the torque changes due to acceleration or braking processes of the motor vehicle 4. Therefore the torque fluctuations can essentially be understood as a superposition of a high-frequency vibration torque onto a slow variable torque. Due to the inertia of the electric machine 3 the torque fluctuations are additionally damped.

What is claimed as new and desired to be protected by Letters Patent is set forth in the appended claims and includes equivalents of the elements recited therein:

What is claimed is:

1. A method for operating an electric machine which is coupled with an output shaft of an internal combustion engine of a motor vehicle, said method comprising:
controlling the electric machine in dependence on at least one operating parameter of at least one of the internal combustion engine and the electric machine so that the electric machine transmits to the output shaft a compensation torque which at least partially compensates torque fluctuations of the internal combustion engine occurring during an operation of the internal combustion engine as a result of an operating phase of the internal combustion engine.

2. The method of claim 1, wherein the electric machine is configured as an outer rotor is used.

3. The method of claim 1, wherein a rotor of the electric machine is coupled with the output shaft in rotative fixed relationship.

4. The method of claim 1, wherein the at least one operating parameter of the electric machine includes at least one of a detected rotation angle of the electric machine and a detected rotational speed of the electric machine.

5. The method of claim 1, wherein the at least one operating parameter is provided by a motor control of the internal combustion engine.

6. The method of claim 1, wherein the at least one operating parameter of the internal combustion engine is at least one of an actual stroke of at least one cylinder of the internal combustion engine and a phase within a stroke.

7. The method of claim 1, further comprising for increasing a drive power of the motor vehicle or for recuperation of energy controlling the electric machine so that the electric machine transmits a torque to the output shaft that is a sum of a predetermined drive power torque or a recuperation torque and a compensation torque which at least partially compensates the torque fluctuations of the internal combustion engine due to the operating phase of the internal combustion engine.

8. A motor vehicle comprising:
an internal combustion engine;
an electric machine coupled with the internal combustion engine; and
a control device for controlling the electric machine, said control device being configured to control the electric machine in dependence on at least one operating parameter of at least one of the internal combustion engine and the electric machine so that the electric machine transmits to the output shaft a compensation torque which at least partially compensates torque fluctuations of the internal combustion engine occurring during an operation of the internal combustion engine as a result of an operating phase of the internal combustion engine.

9. The motor vehicle of claim 8, wherein the electric machine is configured as an external rotor machine.

10. The motor vehicle of claim 8, wherein the rotor of the electric machine is coupled with the output shaft in rotative fixed relationship.
